(19) United States
(12) Patent Application Publication
(10) Pub. No.: US 2006/0170214 A1
(43) Pub. Date: Aug. 3, 2006

(54) Apparatus and method for clamping stud to exhaust manifold

(76) Inventor: Robert Valente, Wethersfield, CT (US)

Correspondence Address: LAW OFFICE OF MICHAEL A. BLAKE, 112 BROAD STREET, MILFORD, CT, 06460, US

(21) Appl. No.: 11/050,067

(22) Filed: Feb. 2, 2005

(51) Int. Cl. F16L 23/00

(52) U.S. Cl. 285/412; 285/368

(57) ABSTRACT

The disclosed apparatus relates to a stud clamp apparatus comprising: a clamping member configured to be located adjacent to an upper surface of an exhaust manifold flange and adjacent to a lower surface of the exhaust manifold flange; a bolt configured to screw into the clamping member and impinge upon the upper surface of the exhaust manifold flange; and a clamping stud configured to screw into the clamping member and towards the lower surface of the exhaust manifold flange, and further configured to couple to an exhaust pipe collar. The disclosed method relates to a method of coupling an exhaust pipe collar to an exhaust manifold comprising: clamping a stud clamp apparatus to the exhaust manifold; sliding the exhaust pipe collar over a clamping stud; threading a nut over the clamping stud to couple the exhaust pipe collar to the exhaust manifold.

### TECHNICAL FIELD

The present invention relates generally to an apparatus and method of repairing an exhaust manifold with a broken stud. More particularly, the present invention relates to an apparatus for clamping a stud to an exhaust manifold.

### BACKGROUND

The problem which is addressed by the present invention is broadly in the automotive field. More precisely, however, the problem relates to the attachment of an exhaust pipe section to the exhaust manifold of an automobile engine. In this regard, the manifold is normally provided with a generally circular flange against which the enlarged end of an exhaust pipe section is adapted to fit. A gasket or washer is generally interposed between the enlarged end of the exhaust pipe section and the seat on the flange. A collar is generally received on the exhaust pipe section on the opposite side of the enlarged portion from the manifold flange. Normally, but not necessarily, two to four studs which are threaded into the manifold flange extend outwardly from the manifold flange and pass through an equal number of holes in the collar. Threaded nuts are placed on the threaded ends of the studs which project through the collar and are thereafter tightened so as to draw the collar close to the manifold to produce a tight connection between the end of the exhaust pipe and the manifold.

Occasionally, when one is replacing an exhaust pipe section, he or she will discover that one or more of the studs has been broken off, generally adjacent the surface of the flange or sometimes even internally within the flange. One of the practices in the past has been to remove the broken stud so as to put a new stud in place. However, this removal generally involves drilling a hole into the broken stud and using an “easy-out” or some other suitable device to remove the broken stud. This method of removing the broken stud is not only difficult, but quite time-consuming. Additionally, this method many times does not work, and requires more drilling, tapping and even blow-torching.

Thus a need for quick, simple and inexpensive method of attaching an exhaust pipe to an exhaust manifold, with one or more broken or inoperative studs, has been identified.

### SUMMARY

The disclosed apparatus relates to a stud clamp apparatus comprising: a clamping member configured to be located adjacent to an upper surface of an exhaust manifold flange and adjacent to a lower surface of the exhaust manifold flange; a bolt configured to screw into the clamping member and impinge upon the upper surface of the exhaust manifold flange; and a clamping stud configured to screw into the clamping member and towards the lower surface of the exhaust manifold flange, and further configured to couple to an exhaust pipe collar.

The disclosed apparatus also relates to a stud clamp apparatus comprising: a first block configured to impinge an upper surface of an exhaust manifold flange; a second block configured to impinge a lower surface of the exhaust manifold flange; a fastener configured to couple to the first block and to couple to the second block; and a clamping stud configured to thread through the second block and towards the lower surface of the exhaust manifold flange and further configured to couple to an exhaust pipe collar.

The disclosed method relates to a method of coupling an exhaust pipe collar to an exhaust manifold comprising: clamping a stud clamp apparatus to the exhaust manifold; sliding the exhaust pipe collar over a clamping stud; threading a nut over the clamping stud to couple the exhaust pipe collar to the exhaust manifold.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a schematic cross-sectional view of one embodiment of the disclosed stud clamp apparatus;

FIG. 2 is a schematic cross-sectional view of another embodiment of the disclosed stud clamp apparatus;

FIG. 3 is a schematic cross-sectional view of yet another embodiment of the disclosed stud clamp apparatus; and

FIG. 4 is a flow chart illustrating one embodiment of the disclosed method.

### DETAILED DESCRIPTION

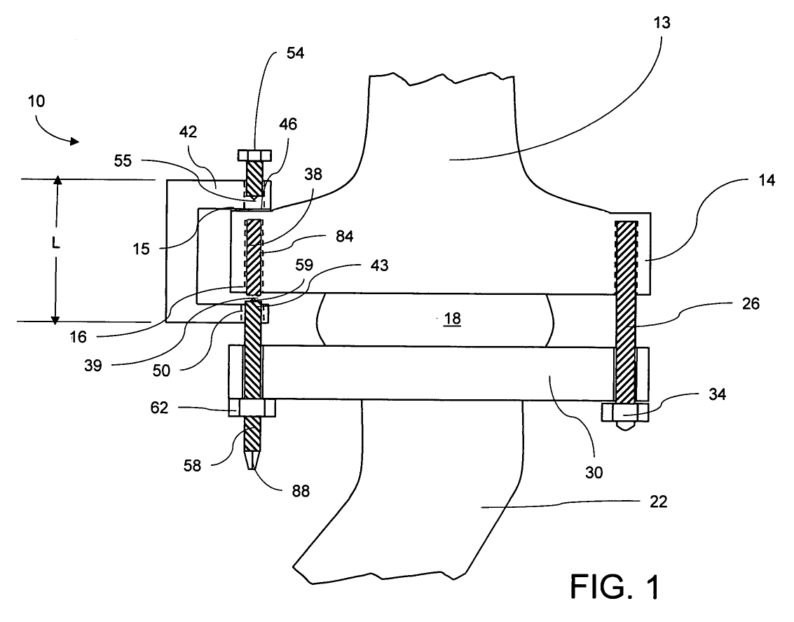

FIG. 1 is a cross-sectional view showing one embodiment of the disclosed stud clamp apparatus 10. An exhaust manifold 13 with an exhaust manifold flange 14 is adjacent to a donut 18 which is adjacent to an exhaust collar 30 which is coupled to an exhaust pipe 22. An unbroken stud 26 is shown coupling the exhaust manifold flange 14 to the exhaust collar 30. A nut 34 is fitted over an end of the stud 26, holding the collar 30 in place relative to the exhaust manifold flange 14. Also shown is a broken stud 38 in the manifold flange 14. The stud clamp apparatus 10 comprises a clamping member 42 with a first threaded hole 46 and a second threaded hole 50. The threaded holes 46, 50 may be fitted with a threadlocking compound or insert. In another embodiment, hole 50 may be unthreaded. A set bolt 54 is threaded into the first hole 46, and may be screwed in until the end of the set bolt 54 abuts against the upper surface 15 of the manifold flange 14. The set bolt 54 may have a gripping surface 55 on an end of the set bolt 54. The gripping surface 55 allows the set bolt 54 to bite or dig into the upper surface 15 of the exhaust manifold flange 14 thereby making a more secure connection. The gripping surface may comprise one or more points that are able to bite or dig into the uppers surface 15. However, the gripping surface 55 is not required on the end of the set bolt 54; the set bolt 54 may have a flat, curved, or any other shaped surface that provides a surface impinge against the manifold flange 14. A clamping stud 58 is threaded through second threaded hole 50. The clamping stud 58 is threaded through the second hole 50 until it abuts against the broken stud 38 or flange 14. A nut 62 is threaded onto the clamping stud 58, and holds the collar 30 against the donut 18. One of ordinary skill in the art will recognize that the disclosed apparatus and method may be configured to work on a exhaust flange/exhaust pipe connection that has no donut 18. The clamping stud 58 may have a gripping surface 59 on a first end 39 of the clamping stud 58. The gripping surface allows the set bolt to bite or dig into the surface of the broken stud 38, thereby making a more secure connection. However, the gripping surface 59 is not required on the end of the clamping stud 58, the clamping stud 58 may have a flat, curved, or any other shaped surface that provides a surface to impinge against the broken stud 38 or flange 14. The clamping stud 58 may be sized such that it is threadable into the manifold flange threaded hole 84, so that if a broken stud 38 is left in the hole 84, the clamping stud 58 will impinge against the broken stud 38. Alternatively, the clamping stud 58 may be sized to be slightly or significantly larger than the threaded hole 84, so that the stud 58 will impinge against the lower surface 16 of the manifold flange 14. In another alternative, the clamping stud 58 may be sized to be slightly smaller than the threaded hole 84, so that the stud 58 can freely enter the hole 84 so the stud 58 will impinge against the broken stud 38, or the interior surface of the hole 84.

A second end 88 of the clamping stud 58 may have a four sided end or a hex head, to allow for a crescent wrench or other tool to be used to turn the clamping stud 58. In other embodiments, the second end 88 may be configured to receive the following non-limiting drive types: Phillips and Frearson, slotted, combination of slotted and Phillips, socket or allen. In still another embodiment, the second end 88 may be configured to receive a wing nut.

The stud clamp apparatus 10 provides a quick and low cost method of attaching an exhaust pipe to an exhaust manifold flange when one or more of the studs 26, 38 are broken, missing, or in a non-working condition. Because the clamping stud 58 can accommodate a nut 62, the apparatus 10 is adjustable and can be used to fit a variety of different sized exhaust manifold flanges 14. Additionally, different length clamping studs may be used to accommodate exhaust manifold flanges 14, donuts 18 and collars 30 of a variety of sizes. Additionally, the clamping member 42 may come in a variety of lengths “L” to accommodate a variety of sizes of exhaust manifold flanges 14. The clamping member 42 may be welded directly to the flange 14, by welding the clamping member 42 at a clamping member surface 43 adjacent to the lower surface 16 of the manifold flange.

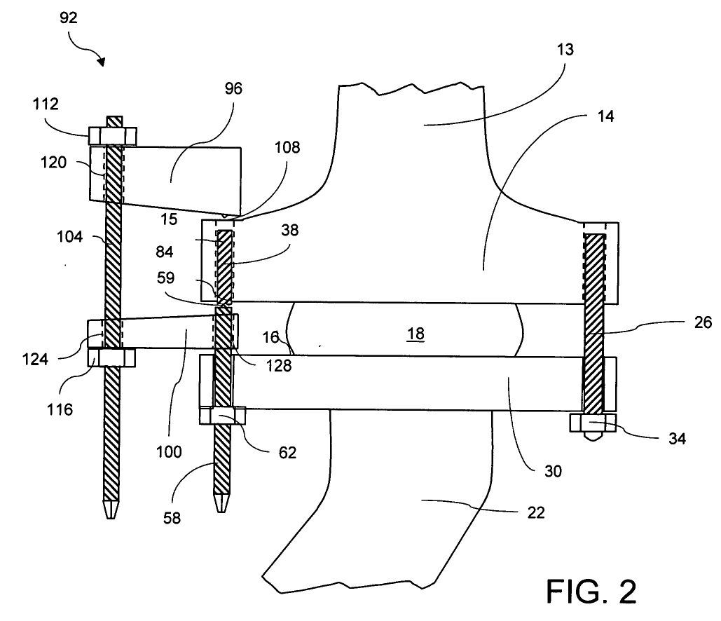

FIG. 2 shows another embodiment of a stud clamp apparatus 92. In this embodiment, a first block 96 and second block 100 are coupled by a bolt 104 through first threaded hole 120 and second hole 124. Hole 124 is non-threaded. The first block 96, second block 100 and bolt 104 act similarly to the clamping member 42 from FIG. 1. The first block 96 has a gripping surface 108, that allows it to bite or dig into the upper surface 15 of the exhaust manifold flange 14 thereby making a more secure connection. The first and second blocks 96, 100 may have a generally trapezoidal shape, to act as a wedge against the manifold flange 14. In another embodiment, first and second blocks 96,100 may be generally rectangular shaped. A first nut 112 and second nut 116 couples to the bolt 104, thereby holding the first and second blocks 96,100 against the exhaust manifold flange 14. A clamping stud 58 is threaded through a threaded hole 128 in the second block 100. In another embodiment, block 100 may be welded directly to the flange 14. As the bolt 104 is tightened into threaded hole 120, the blocks 96 and 100 are drawn together due to the nut 116.

The nuts 34, 62, 112, 116 may be, but are not limited to: standard nuts, locking nuts, hex nuts, and other shaped nuts. Additionally the nuts 34, 62,112, 116 may be welded to the clamp apparatus 10, 92, exhaust manifold flange 14, or exhaust collar 30. In another embodiment, the clamping member 42 may be welded directly to the flange 14.

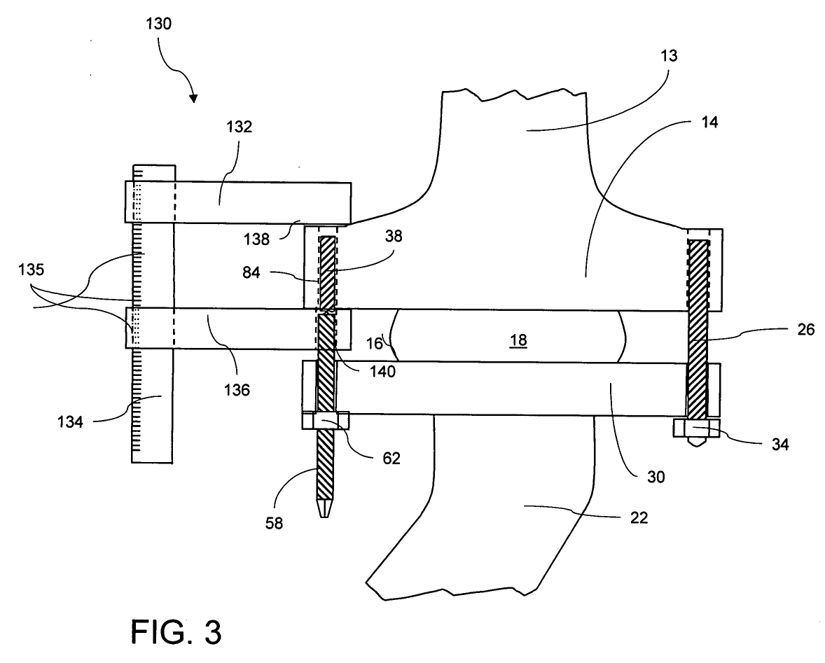

FIG. 3 shows another embodiment of the stud clamp apparatus 130. In this embodiment, a first block 132 is coupled to a slotted rod 134. The slotted rod is coupled to a second block 136. One or more of the blocks 132,136 are adjustably coupled to the slotted rod 134. One or more of the blocks 132,136 may slide up and down the rod 134, and lock into place on one or more of the slots 135 located on the rod. Block 132 may have a gripping surface 138 located on a side adjacent to the flange 14. Block 136 has a threaded hole 142, which allows a clamping stud 58 to attach to the block 136, and impinge against flange 14 or broken stud 38. A person of ordinary skill in the art will recognize that one may use a sliding bar with out slots, for instance a locking pin to hold one or more of the blocks 132, 134 in place relative to the sliding bar, or some other infinitely adjustable mechanism to hold blocks 132, 136 in place.

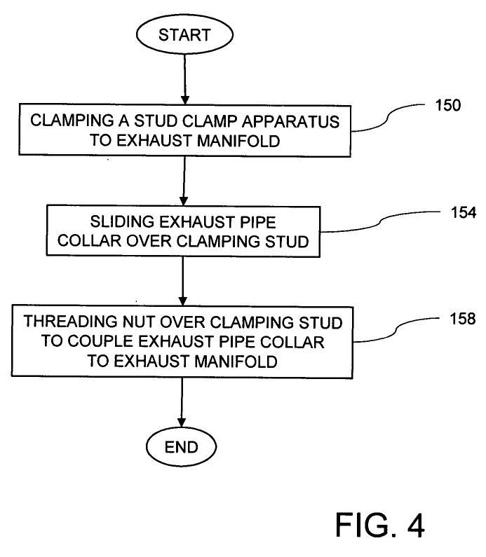

FIG. 4 is a flow chart illustrating a method of the invention. The first act 150 is clamping a stud clamp apparatus to an exhaust manifold. The next act 154 is sliding an exhaust pipe collar over a clamping stud. The next act 158 is threading a nut over the clamping stud in order to couple the exhaust pipe collar to the exhaust manifold.

It should also be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims

What is claimed is:

1. A stud clamp apparatus comprising:
a clamping member configured to be located adjacent to an upper surface of an exhaust manifold flange and adjacent to a lower surface of the exhaust manifold flange;
a bolt configured to screw into the clamping member and impinge upon the upper surface of the exhaust manifold flange; and
a clamping stud configured to screw into the clamping member and towards the lower surface of the exhaust manifold flange, and further configured to couple to an exhaust pipe collar.

2. The stud clamp apparatus of claim 1, wherein the bolt comprises an end with a gripping surface.

3. The stud clamp apparatus of claim 1, wherein the clamping stud comprises an end with a gripping surface.

4. The stud clamp apparatus of claim 1, wherein the clamping stud is configured to impinge against the lower surface of the exhaust manifold flange.

5. The stud clamp apparatus of claim 1, wherein the clamping stud is configured to impinge against a broken stud in an exhaust manifold flange.

6. The stud clamp apparatus of claim 1, wherein the clamping stud is configured to impinge against an interior surface of a stud hole in an exhaust manifold flange.

7. The stud clamp apparatus of claim 1, wherein the clamping stud comprises an end selected from the group consisting of a male allen head end, a female allen head end, a Frearson slotted end, a socket end, a Phillips slotted end, and a hex head end.

8. The stud clamp apparatus of claim 1, wherein the clamping stud comprises an end configured to accept a wing nut.

9. A stud clamp apparatus comprising:
a first block configured to impinge an upper surface of an exhaust manifold flange;
a second block configured to impinge a lower surface of the exhaust manifold flange;
a fastener configured to couple to the first block and to couple to the second block; and
a clamping stud configured to thread through the second block and towards the lower surface of the exhaust manifold flange and further configured to couple to an exhaust pipe collar.

10. The stud clamp apparatus of claim 9, wherein the fastener is a threaded bolt configured to thread through the first block and further configured to slideably couple to the second block.

11. The stud clamp apparatus of claim 10, wherein the first block and second block are generally trapezoidally shaped.

12. The stud clamp apparatus of claim 9, wherein the first block has a gripping surface configured to bite into an upper surface of the exhaust manifold.

13. The stud clamp apparatus of claim 9, wherein the clamping stud is configured to impinge against the lower surface of the exhaust manifold flange.

14. The stud clamp apparatus of claim 9, wherein the clamping stud is configured to impinge against a broken stud in an exhaust manifold flange.

15. The stud clamp apparatus of claim 9, wherein the clamping stud is configured to impinge against an interior surface of a stud hole in an exhaust manifold flange.

16. The stud clamp apparatus of claim 9, wherein the clamping stud comprises an end selected from the group consisting of a male allen head end, a female allen head end, a Frearson slotted end, a socket end, a Phillips slotted end, and a hex head end.

17. The stud clamp apparatus of claim 9, wherein the fastener is a rod adjustably coupled to the first block and the second block.

18. The stud clamp apparatus of claim 17, wherein the rod is a slotted rod.

19. The stud clamp apparatus of claim 17, wherein the rod is configured to couple to a locking pin in order to fix the location of at least one of the first block and the second block.

20. A method of coupling an exhaust pipe collar to an exhaust manifold comprising:
clamping a stud clamp apparatus to the exhaust manifold;
sliding the exhaust pipe collar over a clamping stud;
threading a nut over the clamping stud to couple the exhaust pipe collar to the exhaust manifold.
